(19) United States
(12) Patent Application Publication
(10) Pub. No.: US 2024/0217095 A1
(43) Pub. Date: Jul. 4, 2024

(54) SINGLE AXIS ROBOT

(71) Applicant: AAC Microtech (Changzhou) Co., Ltd., Changzhou (CN)

(72) Inventors: Chongdeng Wu, Changzhou (CN); Qihuan Zhu, Changzhou (CN); Xueyuan Zhu, Changzhou (CN); Shun Guo, Changzhou (CN); Weiling Shi, Changzhou (CN)

(21) Appl. No.: 18/338,367

(22) Filed: Jun. 21, 2023

Related U.S. Application Data
(63) Continuation of application No. PCT/CN2023/075331, filed on Feb. 10, 2023.

(30) Foreign Application Priority Data
Dec. 30, 2022 (CN) 202211722562.8

(51) Int. Cl. B25J 9/02; B25J 9/00; B25J 9/10; B25J 9/12

(52) U.S. Cl. CPC B25J 9/02; B25J 9/0009; B25J 9/108; B25J 9/126

(57) ABSTRACT

A single axis robot includes: a base plate, a first guiding unit extending along a first direction, a first slider, a driver, a second guiding unit extending along a second direction, a second slider and a third guiding unit extending along a third direction. The first end of the first slider is connected to the first guiding unit to realize guiding fitting. The driver is connected to the first slider. The second guiding unit is provided at a second end of the first slider. A first end of the second slider and the second end of the first slider form guiding fitting. A plane of the third direction is perpendicular to a plane of the first direction. With the first and second sliders and the first, second and third guiding units, the movement along the axial direction of the driving screw is converted into movement in a direction perpendicular thereto.

### TECHNICAL FIELD

The present disclosure relates to the field of robots and, particularly, relates to a single axis robot.

### BACKGROUND

The existing single axis robot generally includes a combined structure of a driving screw and a rotary motor. The driving screw is rotationally supported by a bearing seat. An output shaft of the rotary motor is connected to the driving screw through a coupling. A screw nut is in threaded connection with the driving screw. An output member is fixed on the screw nut. The rotary motor operates and drives the driving screw to rotate, and thus causes the screw nut to move along an axial direction of the driving screw. The movement direction of the output member is parallel to the axial direction of the driving screw. As a result, the output member cannot move in a direction perpendicular to the axial direction of the driving screw.

### SUMMARY

Embodiments of the present disclosure provide a single axis robot capable of converting movement along the axial direction of the driving screw into movement in a direction perpendicular to the axial direction of the driving screw.

The single axis robot includes: a base plate, a first guiding unit, a first slider, a driver, a second guiding unit, a second slider, and a third guiding unit. The first guiding unit is provided on the base plate and extends along a first direction. A first end of the first slider is connected to the first guiding unit to realize guiding fitting. The driver is connected to the first slider and configured to drive the first slider to move along the first direction. The second guiding unit is provided at a second end of the first slider and extends along a second direction, and the second direction and the first direction jointly define a preset angle. A first end of the second slider and the second end of the first slider form guiding fitting. The third guiding unit extends along a third direction and connected to a second end of the second slider to realize guiding fitting, and a plane of the third direction being perpendicular to a plane of the first direction.

As an improvement, the second end of the first slider is provided with a first guiding slope, the first end of the second slider is provided with a second guiding slope, and the second slider is connected to the second guiding unit through the second guiding slope to realize guiding fitting.

As an improvement, the driver includes: a driving motor, a driving screw, a screw nut, a bearing seat and a coupling. An output shaft of the driving motor is connected to the driving screw through the coupling, the driving screw is rotationally supported by the bearing seat, the screw nut is in threaded fitting with the driving screw, and the first slider is fixedly connected to the screw nut.

As an improvement, the base plate is provided with a mounting member having an accommodating cavity formed therein, each of the first slider and the second slider includes at least a part accommodated in the accommodating cavity, and the third guiding unit is fixed to an inner wall of the accommodating cavity.

As an improvement, the mounting member includes a first board, a second board, a third board and a fourth board, wherein the first board, the second board, the third board and the fourth board are sequentially connected to jointly define the accommodating cavity, and the third guiding unit is provided on an inner wall surface of the first board.

As an improvement, the robot further includes a zero-return switch located in the accommodating cavity, and the zero-return switch is a starting end of a movement path of the second slider.

As an improvement, the preset angle is within a range of 0 to 90°.

As an improvement, the preset angle is 45°.

As an improvement, the first guiding unit includes a cross guiding rail pair, the second guiding unit includes a cross guiding rail pair, and the third guiding unit comprises a straight guiding rail pair, or the first guiding unit, the second guiding unit, and the third guiding unit are all straight guiding rail pairs.

As an improvement, the second slider is provided with an output adapter unit.

The single axis robot in embodiments of the present disclosure includes a first slider and a second slider, with the guiding action of the first guiding unit, the second guiding unit, and the third guiding unit, the movement of the first slider along the first direction is converted into movement of the second slider along the third direction. The driver includes a driving motor. The driving motor cooperates with the driving screw to drive the first slider to move along the first direction. The third direction is perpendicular to the first direction. The first direction is the horizontal direction. The third direction is the gravity direction. In this way, the movement along the axial direction of the driving screw is converted into movement in a direction perpendicular to the axial direction of the driving screw.

### BRIEF DESCRIPTION OF DRAWINGS

FIG. 1 is a perspective view showing an overall structure of a single axis robot according to embodiments of the present disclosure.

FIG. 2 is a plan view showing an overall structure of a single axis robot according to embodiments of the present disclosure.

FIG. 3 is a cross-sectional view taken along line A-A in FIG. 2.

FIG. 4 is an exploded view showing an overall structure of a single axis robot according to embodiments of the present disclosure.

FIG. 5 is a perspective view showing an overall structure of a single axis robot with some elements being hidden according to a first embodiment of the present disclosure.

FIG. 6 is another perspective view showing an overall structure of a single axis robot with some elements being hidden according to the first embodiment of the present disclosure.

FIG. 7 is a perspective view of a first slider according to the first embodiment of the present disclosure.

FIG. 8 is a front view of the first slider according to the first embodiment of the present disclosure.

FIG. 9 is a perspective view of a second slider according to the first embodiment of the present disclosure.

FIG. 10 is a front view of the second slider according to the first embodiment of the present disclosure.

FIG. 11 is a perspective view showing an overall structure of a single axis robot with some elements being hidden according to a second embodiment of the present disclosure.

FIG. 12 is an exploded view showing an overall structure of a single axis robot according to embodiments of the present disclosure.

### REFERENCE SIGNS

10: base plate;
20: first guiding unit;
30: first slider; 31: first guiding slope;
40: driver; 41: driving motor; 42: driving screw; 43: screw nut; 44: bearing seat;
45: coupling; 46: motor fixing seat;
50: second guiding unit;
60: second slider; 61: second guiding slope;
70: third guiding unit;
80: mounting member; 81: accommodating cavity; 82: through hole; 83: first board; 84: second board; 85: third board; 86: fourth board; 87: zero-return switch;
90: output adapter unit.

### DESCRIPTION OF EMBODIMENTS

Embodiments described hereafter with reference to the drawings are illustrative, merely used for explaining the present invention and should not be regarded as any limitations thereto.

### First Embodiment

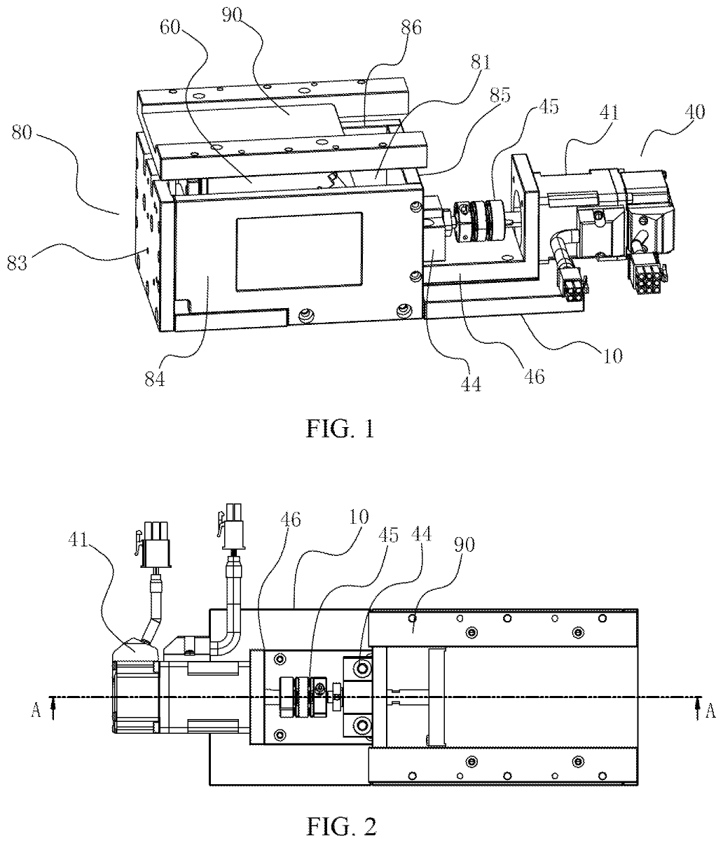

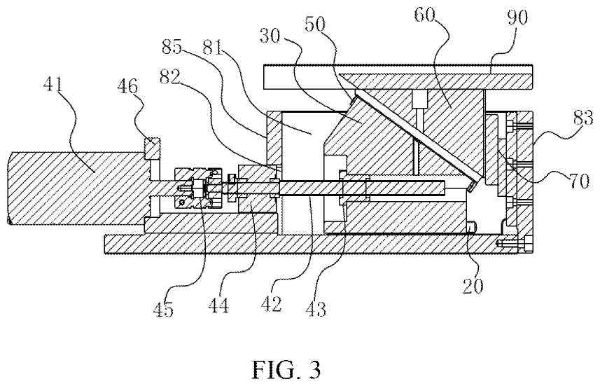

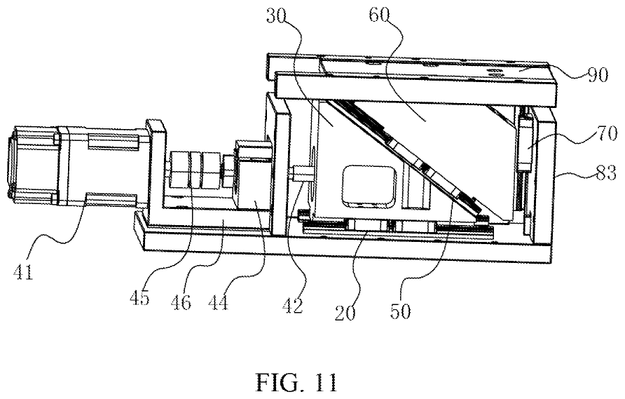

A single axis robot is provided. As shown in FIG. 1 to FIG. 10, the single axis robot includes: a base plate 10, a first guiding unit 20, a first slider 30, a driver 40, a second guiding unit 50, a second slider 60, and a third guiding unit 70.

The base plate 10 is a horizontally extended flat plate structure and serves as a base for supporting and mounting the single axis robot.

The first guiding unit 20 is provided on the base plate 10 and extends along a first direction.

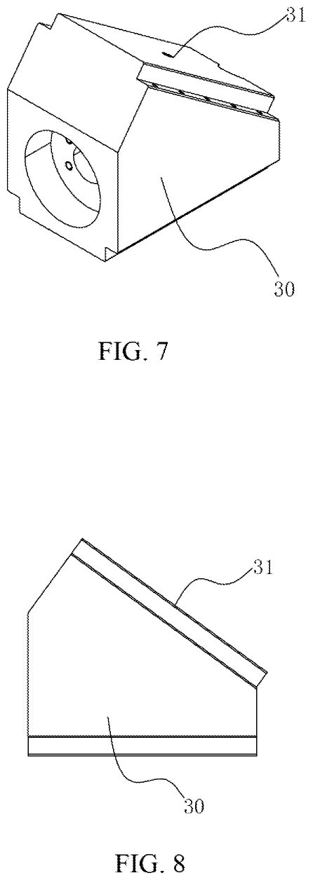

As shown in FIG. 7 and FIG. 8, a first end of the first slider 30 is connected to the first guiding unit 20. The first guiding unit 20 is configured to guide the first slider 30 to move along the first direction. A second end of the first slider 30 is provided with a first guiding slope 31. In some embodiments of the present disclosure, a bottom end of the first slider 30 is connected to the first guiding unit 20. The first guiding slope 31 is provided at a top end of the first slider 30. The first direction is in a horizontal plane. The first guiding unit 20 provides limiting and guiding functions, such that the first slider 30 moves only along the first direction.

The driver 40 is connected to the first slider 30 and configured to drive the first slider 30 to move along the first direction.

The second guiding unit 50 is provided on the first guiding slope 31. The second guiding unit 50 extends along a second direction. A preset angle exists between the second direction and the first direction. A top end of the second guiding unit 50 is closer to the driver 40 than a bottom end of the second guiding unit 50.

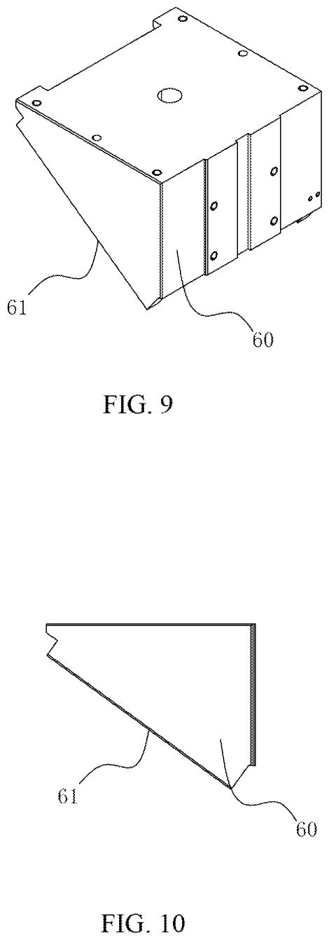

As shown in FIG. 8 and FIG. 9, a first end of the second slider 60 is provided with a second guiding slope 61. The second guiding slope 61 is connected to the second guiding unit 50. In some embodiments of the present disclosure, the second guiding slope 61 is provided at a bottom end of the second slider 60. The first guiding slope 31, the second guiding slope 61 and the second guiding unit 50 are all inclined with respect to the horizontal plane and extend along a same direction. The preset angle between the second direction and the first direction is within a range of 0 to 90° excluding 0 and 90°. When moving horizontally along the first direction, the first slider 30 abuts the second slider 60 and applies a vertical force to the second slider 60. Optionally, the preset angle between the second direction and the first direction is 45°. With such preset angle, the vertical force applied to the second slider 60 is relatively large without slowing the movement of the first slider 30.

The third guiding unit 70 is connected to the second end of the second slider 60 and extends along a third direction. The third guiding unit 70 is configured to guide the second slider 60 to move along the third direction. The third direction and the first direction are perpendicular to each other. In some embodiments of the present disclosure, the third guiding unit 70 is connected to a side end of the second slider 60. The third direction is in a vertical plane. The third guiding unit 70 provides limiting and guiding functions, such that the second slider 60 moves only along the third direction.

Based on the above embodiments, the operating process of the single axis robot is as follows.

In an initial state, the driver 40 operates and drives the first slider 30 to move. With the guiding action of the first guiding unit 20, the first slider 30 moves along the first direction. During the movement of the first slider 30, a force is transmitted to the second slider 60. Specifically, the first slider 30 applies a vertical force to the second slider 60. With the restricting and guiding of the third guiding unit 70, the second slider 60 only moves vertically along the gravity direction.

In some embodiments, as shown in FIG. 1 and FIG. 3 to FIG. 6, the driver 40 includes a driving motor 41, a driving screw 42, a screw nut 43, a bearing seat 44 and a coupling 45. The base plate 10 is provided with a motor fixing seat 46. The motor fixing seat 46 has an L-shaped structure. A horizontal section of the motor fixing seat 46 is detachably fixed on the base plate 10 by means of bolts. The driving motor 41 is fixed to a vertical section of the motor fixing seat 46. In order to ensure the precise and stable operation of the driving motor 41, the driving motor 41 is a servo motor. The bearing seat 44 is fixed to the horizontal section of the motor fixing seat 46. The driving screw 42 is rotationally supported by the bearing seat 44. The extending direction of the driving screw 42 is parallel to the first direction. The screw nut 43 is in threaded fitting with driving screw 42. The first slider 30 is fixedly connected to the screw nut 43. The output shaft of the driving motor 41 is connected to the driving screw 42 through the coupling 45.

When the driving motor 41 operates, power is transferred to the driving screw 42 through the coupling 45, and the driving screw 42 is driven to rotate. With the threaded connection between the driving screw 42 and the screw nut 43, the rotation of the driving screw 42 is converted into a horizontal movement of the screw nut 43 along the axial direction of the driving screw 42, and thus the first slider 30 moves along the first direction.

In some embodiments, as shown in FIG. 1 and FIG. 4 to FIG. 6, the base plate 10 is provided with a mounting member 80. The mounting member 80 is detachably fixed on the base plate 10 by means of bolts. An accommodating cavity 81 is provided in the mounting member 80. The accommodating cavity 81 is a recess formed on the top of the mounting member 80. Each of the first slider 30 and the second slider 60 includes at least a part accommodated in the accommodating cavity 81, so the accommodating cavity 81 protects the first slider 30 and the second slider 60. The third guiding unit 70 is fixed to an inner wall of the accommodating cavity 81. The second slider 60 is connected to the third guiding unit 70. Since the accommodating cavity 81 is exposed by the top side, the affecting to the vertical movement of the second slider 60 is avoided. An inner wall of the accommodating cavity 81 opposite to the third guiding unit 70 is provided with a through hole 82 allowing the driving screw 42 to pass through.

In some embodiments, as shown in FIG. 1 and FIG. 3 to FIG. 6, the mounting member 80 includes a first board 83, a second board 84, a third board 85 and a fourth board 86. Bottoms of the first board 83, the second board 84, the third board 85 and the fourth board 86 are detachably fixed on the base plate 10 by means of bolts. The first board 83, the second board 84, the third board 85 and the fourth board 86 are sequentially connected to define and enclose to form the accommodating cavity 81. The first board 83 and the third board 85 are opposite to each other. The second board 84 and the fourth board 86 are opposite to each other. The third guiding unit 70 is provided on an inner wall surface of the first board 83. The through hole 82 is provided on the third board 85. The first slider 30 and the second slider 60 are both accommodated in the accommodating cavity 81.

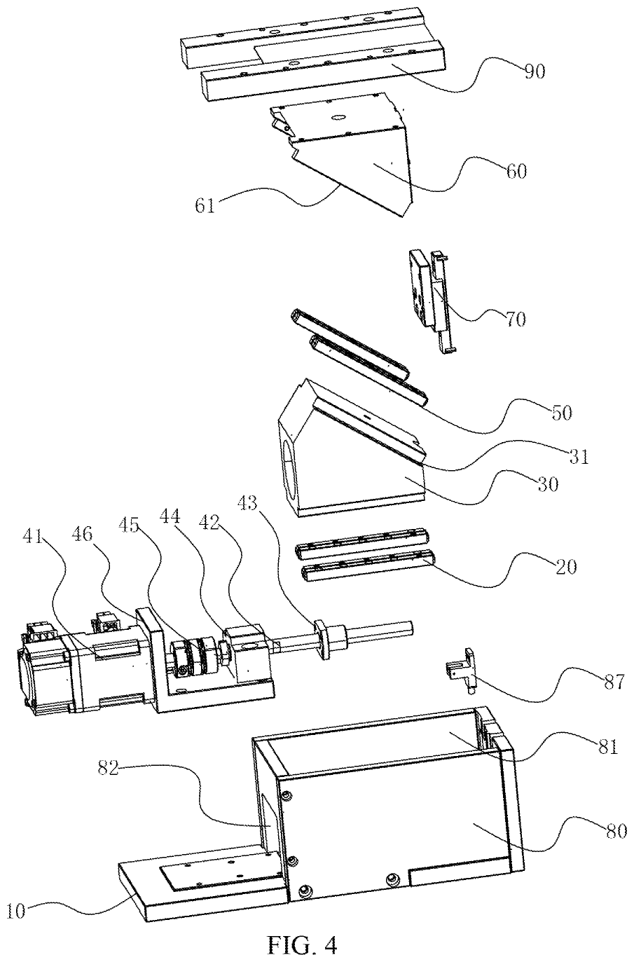

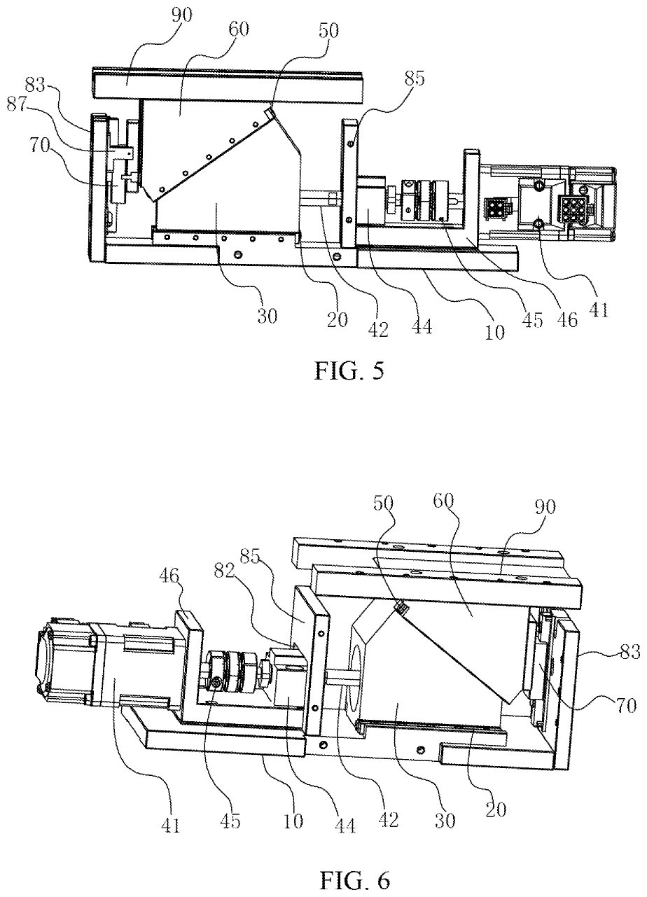

In some embodiments, as shown in FIG. 4 and FIG. 5, a zero-return switch 87 is arranged in the accommodating cavity 81. The zero-return switch 87 is on the movement path of the second slider 60 along the third direction. The zero-return switch 87 is at a starting end of the movement path of the second slider 60. The zero-return switch 87 is used for determining the starting reference point of the second slider 60. The zero-return switch 87 serves as the original point of the motion of the robot. Each time the robot is powered on, the zero-return action is triggered. Returning to the starting reference point is one of important functions of the robot. Whether the robot can accurately return to the starting reference point will affect the processing quality of the robot. For the structure of the zero-return switch 87, reference can be made to related arts, and will not be repeated here.

In some embodiments, an ending end of the movement path of the second slider 60 is provided with a limit switch for limiting the moving displacement distance of the second slider 60. With the limit switch, the movement of the second slider 60 is safe, reliable and stable. For the structure of the limit switch, reference can be made to related arts, and will not be repeated here.

In some embodiments, as shown in FIG. 4, each of the first guiding unit 20 and the second guiding unit 50 includes a cross guiding rail pair, and the third guiding unit 70 includes a straight guiding rail pair. The cross guiding rail pair includes: a stationary rail, a sliding rail, and a roller retainer. The stationary rail and the sliding rail are respectively connected to two sides of the roller retainer though a V-shaped groove. The sliding rail is slidable with respect to the stationary rail by means of the roller retainer. The straight guiding rail pair includes a guiding rail and a sliding block slidably provided on the straight guiding rail.

In some embodiments, the cross guiding rail pair of the first guiding unit 20 extends along the first direction, the stationary rail of the first guiding unit 20 is connected to the base plate 10, and the sliding rail of the first guiding unit 20 is connected to the first slider 30, such that the first slider 30 is guided to slide along the first direction with respect to the base plate 10. The cross guiding rail pair of the second guiding unit 50 extends along the second direction, the stationary rail of the second guiding unit 50 is connected to the first guiding slope 31 of the first slider 30, and the sliding rail of the second guiding unit 50 is connected to the second guiding slope 61 of the second slider 60, such that the second slider 60 is guided to slide along the second direction with respect to the first slider 30. The straight guiding rail pair of the third guiding unit 70 extends along the third direction. The guiding rail is provided on the first board 83, and the sliding block is fixed to the second slider 60. In this way, the second slider 60 is guided to slide along the third direction with respect to the first board 83. It is noted that the positions of the stationary rail and the sliding rail may be exchanged, and the positions of the guiding rail and the sliding block may be exchanged, which are not limited in the present disclosure.

In some embodiments, as shown in FIG. 4, the second slider 60 is provided with an output adapter unit 90 for connecting to the end actuator (not shown). By replacing the output adapter unit, different types of end actuators can be applied to the robot.

### Second Embodiment

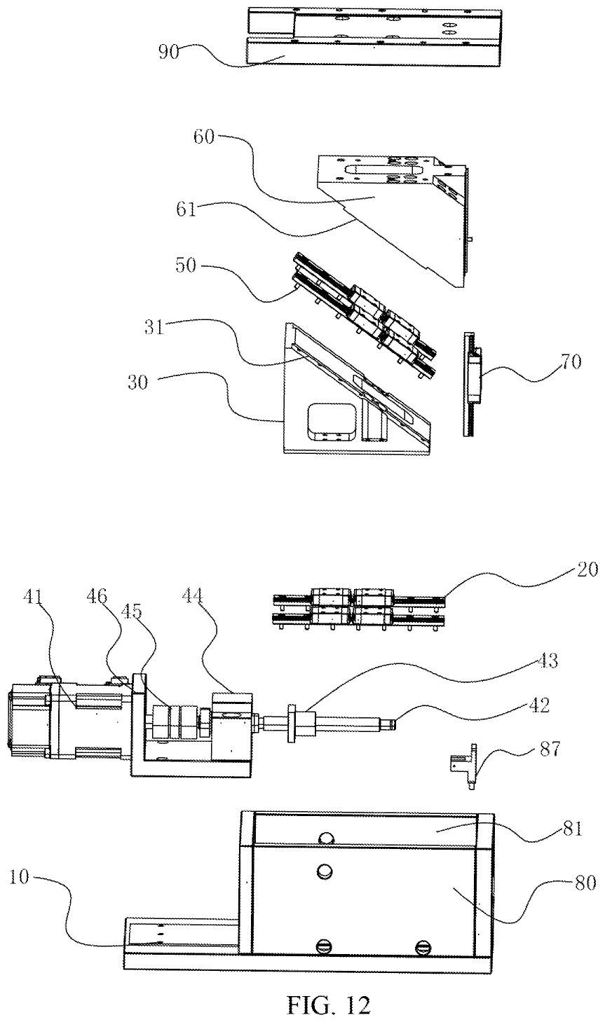

The second embodiment differs from the first embodiment in the configuration of the guiding units. As shown in FIG. 11 and FIG. 12, the first guiding unit 20, the second guiding unit 50, and the third guiding unit 70 are all straight guiding rail pairs.

In some embodiments, the straight guiding rail pair of the first guiding unit 20 extends along the first direction, the guiding rail is provided on the base plate 10, and the sliding block is connected to the first slider 30, such that the first slider 30 is guided to slide along the first direction with respect to the base plate 10. The straight guiding rail pair of the second guiding unit 50 extends along the second direction, the guiding rail is connected to the first guiding slope 31 of the first slider 30, and the sliding block is connected to the second guiding slope 61 of the second slider 60, such that the second slider 60 is guided to slide along the second direction with respect to the first slider 30. The straight guiding rail pair of the third guiding unit 70 extends along the third direction. The guiding rail is provided on the first board 83, and the sliding block is fixed to the second slider 60. In this way, the second slider 60 is guided to slide along the third direction with respect to the first board 83. It is noted that the positions of the guiding rail and the sliding block may be exchanged, which are not limited in the present disclosure.

The structure, features and effects of the present disclosure are described in detail above according to the embodiments shown in the drawings. The above are only preferred embodiments of the present disclosure, but the present disclosure does not limit the scope of implementation as illustrated in the drawings. Any changes made in accordance with the conception of the present disclosure, or equivalent embodiments modified as equivalent changes, which still do not exceed the spirit covered by the specification and the drawings, shall fall within the protection scope of the present disclosure.

What is claimed is:

1. A single axis robot, comprising:
a base plate;
a first guiding unit provided on the base plate and extending along a first direction;
a first slider, a first end of the first slider being connected to the first guiding unit to realize guiding fitting;
a driver connected to the first slider and configured to drive the first slider to move along the first direction;
a second guiding unit provided at a second end of the first slider and extending along a second direction, the second direction and the first direction jointly defining a preset angle;
a second slider, a first end of the second slider forming guiding fitting with the second end of the first slider; and
a third guiding unit extending along a third direction and connected to a second end of the second slider to realize guiding fitting, a plane of the third direction being perpendicular to a plane of the first direction.

2. The single axis robot according to claim 1, wherein the second end of the first slider is provided with a first guiding slope, the first end of the second slider is provided with a second guiding slope, and the second slider is connected to the second guiding unit through the second guiding slope to realize guiding fitting.

3. The single axis robot according to claim 1, wherein the driver comprises a driving motor, a driving screw, a screw nut, a bearing seat and a coupling, an output shaft of the driving motor is connected to the driving screw through the coupling, the driving screw is rotationally supported by the bearing seat, the screw nut is in threaded fitting with the driving screw, and the first slider is fixedly connected to the screw nut.

4. The single axis robot according to claim 1, wherein the base plate is provided with a mounting member having an accommodating cavity formed therein, each of the first slider and the second slider comprises at least a part accommodated in the accommodating cavity, and the third guiding unit is fixed to an inner wall of the accommodating cavity.

5. The single axis robot according to claim 4, wherein the mounting member comprises a first board, a second board, a third board and a fourth board, wherein the first board, the second board, the third board and the fourth board are sequentially connected to jointly define the accommodating cavity, and the third guiding unit is provided on an inner wall surface of the first board.

6. The single axis robot according to claim 4, further comprising a zero-return switch located in the accommodating cavity, wherein the zero-return switch is a starting end of a movement path of the second slider.

7. The single axis robot according to claim 1, wherein the preset angle is within a range of 0 to 90°.

8. The single axis robot according to claim 1, wherein the preset angle is 45°.

9. The single axis robot according to claim 1, wherein the first guiding unit comprises a cross guiding rail pair, the second guiding unit comprises a cross guiding rail pair, and the third guiding unit comprises a straight guiding rail pair, or wherein the first guiding unit, the second guiding unit, and the third guiding unit are all straight guiding rail pairs.

10. The single axis robot according to claim 1, wherein the second slider is provided with an output adapter unit.
